(19) United States
(12) Patent Application Publication
(10) Pub. No.: US 2008/0002100 A1
(43) Pub. Date: Jan. 3, 2008

(54) Illumination Device and Display Device Using Illumination Device

(76) Inventors: Hiroki Kaneko, Hitachinaka (JP); Toshiaki Tanaka, Hitachi (JP); Yutaka Akiba, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/768,218

(22) Filed: Jun. 26, 2007

(30) Foreign Application Priority Data
Jun. 30, 2006 (JP) 2006-180628

(51) Int. Cl. G02F 1/13357; F21V 7/04

(52) U.S. Cl. 349/65; 349/62; 362/231; 362/240

(57) ABSTRACT

An illumination device includes trains of lead frames and a plurality of light-emitting diodes provided in series on the lead frames. The trains of the lead frames are juxtaposed, and the light-emitting diodes are sealed with a reflecting resin and a transparent resin over a substrate. Gaps are provided between the lead frames and the substrate. The illumination device is employed as a backlight source in a display device.

### BACKGROUND OF THE INVENTION

The present invention relates to illumination devices having light-emitting diodes and to display devices having such illumination device used as a backlight source for a nonluminous type display panel.

With the recent improvement of the emission efficiency of light-emitting diodes, light sources in various kinds of illumination devices have been changed from fluorescent lamps or other lamps to light-emitting diodes. This is because the light-emitting diodes are advantageous in many points, that is, they are smaller in size, are capable of multi-colored light emission, are easily controllable, consume small electric power, and so forth. Still, one light-emitting diode does not have an sufficient light output for illumination use in which a high light output is required, so that an illumination device needs an array of plural light-emitting diodes.

JP-A-2004-319458 describes an illumination device used as a backlight source for a liquid crystal display, in which a plurality of packages each having red, green and blue light-emitting diodes sealed with a transparent resin are arrayed on a wiring board, and a white reflecting member covers the wiring board.

### SUMMARY OF THE INVENTION

In the structure described in JP-A-2004-319458, each package is connected to electrodes on the wiring board with solder, which may, when potential differences appear between electrodes, cause migration to lead to short-circuits and other problems. Further, in a structure in which a plurality of light-emitting diodes are connected in series by use of lead frames and rows of lead frames are juxtaposed thereby to form a backlight unit, since the applied voltages to the respective rows of lead frames are different and the periods of the voltage application are also different from one another, potential differences may appear between the rows of lead frames which causes migration through the surfaces of the board or an adhesive layer. These problems are more serious with a structure in which light-emitting diodes of the same color emitting red, green or blue light are connected in series by use of lead frames.

An object of the present invention is to provide an illumination device being free from the above-mentioned problems and having a high reliability.

Another object of the present invention is to provide a display device using such illumination device.

In one aspect of the present invention, an illumination device includes a substrate, a plurality of lead frames provided on the substrate, a plurality of light-emitting diodes connected in series by the plurality of lead frames, and transparent resin blocks placed on the lead frames and sealing the light-emitting diodes, in which gaps are provided between the lead frames and the substrate.

In another aspect of the present invention, in the illumination device, a reflecting resin block is provided to surround each of the light-emitting diodes on the lead frames so that the transparent resin blocks are placed on each reflecting resin block thereby to seal the light-emitting diodes.

In another aspect of the present invention, in the illumination device, each of the lead frames has clinched portions so that the each lead frame is partly not in contact with the substrate.

In another aspect of the present invention, in the illumination device, the clinched portion of each lead frame has a rising part standing off the substrate.

In another aspect of the present invention, in the illumination device, the clinched portion is provided at a place where the lead frame is in contact with the reflecting resin block or with the transparent resin block.

In another aspect of the present invention, in the illumination device, the substrate has recesses on one surface on which the lead frames are provided so that the gaps are formed between the substrate and the lead frames at the recesses.

In another aspect of the present invention, in the illumination device, a silver layer is provided between each of the light-emitting diodes and the associated lead frame.

In another aspect of the present invention, in the illumination device, an adhesive layer is provided on one surface of the substrate so that the lead frames are placed on the adhesive layer.

In another aspect of the present invention, in the illumination device, at least those of the lead frames which are adjacent to each other have areas contacted to their associated reflecting resin blocks or to their associated transparent resin blocks at different positions from each other.

In another aspect of the present invention, in the illumination device, at least those of the lead frames which are adjacent to each other are exposed from their associated reflecting resin blocks or from their associated transparent resin blocks at positions different from each other as viewed in a direction transverse to the series-connected light-emitting diodes.

In another aspect of the present invention, in the illumination device, the reflecting resin blocks or the transparent resin blocks have depressed portions or protruding portions in a plane parallel with the substrate, the lead frames being exposed from the depressed or protruding portions of the reflecting resin blocks or of the transparent resin blocks.

In another aspect of the present invention, in the illumination device, the light-emitting diodes include those capable of emitting light in a red wavelength region, those capable of emitting light in a green wavelength region and those capable of emitting light in a blue wavelength region, and those emitting light of the same colors are connected in series by the respective lead frames.

In another aspect of the present invention, in the illumination device, a number of the lead frames series-connecting light-emitting diodes capable of emitting light in a red wavelength region, that of the lead frames series-connecting light-emitting diodes capable of emitting light in a green wavelength region and that of the lead frames series-connecting light-emitting diodes capable of emitting light in a blue wavelength region are in a ratio of 1:2:1.

In another aspect of the present invention, in the illumination device, two trains of lead frames series-connecting light-emitting diodes which emit light in a green wavelength region are arranged to be adjacent to each other.

In another aspect of the present invention, in the illumination device, the light-emitting diodes include those capable of emitting light in a blue wavelength region or in a purple wavelength region, and a fluorescent material is provided on the reflecting resin blocks, the fluorescent material being excitable with light in the blue wavelength region or in the purple wavelength region for emission of light.

In another aspect of the present invention, a liquid crystal display device includes a backlight source having at least one illumination device as described above, a liquid crystal display panel to be supplied with light from the backlight source, and an assembly of optical elements arranged between the backlight source and the liquid crystal display panel for controlling uniformity and directivity of light from the backlight source.

In another aspect of the present invention, in the liquid crystal display device, the backlight source has the illumination device arranged on the side surface of the liquid crystal display panel and a light guiding plate for letting in light from the illumination device to the liquid crystal display panel, the illumination device being not on the main surface sides of the crystal display panel.

In another aspect of the present invention, in the liquid crystal display device, the backlight source has plural sets of an illumination device and a light guiding plate, the illumination device in each of the sets being of the type described above, the light guiding plate in each set for letting in light from its associated illumination device to the liquid crystal display panel, the plural sets of an illumination device and a light guiding plate being arranged in matrix or in rows and columns.

According to any one of the above-described aspects of the present invention, it is possible to provide an illumination device using light-emitting diodes which has a high reliability and is almost free from failures caused by migration and to provide a display device using the illumination device.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective view of an illumination device according to First Embodiment of the present invention.

FIG. 2 is a crosssectional view of an illumination device according to First Embodiment of the present invention.

FIG. 3 is a plan view of an illumination device according to First Embodiment of the present invention.

FIG. 4 is a diagram of an electric circuit in First Embodiment of the present invention.

FIG. 5 is another crosssectional view of an illumination device according to First Embodiment of the present invention.

FIG. 6 is still another crosssectional view of an illumination device according to First Embodiment of the present invention.

FIG. 7A is a crosssectional view illustrating an example of a manner of mounting a light-emitting diode in the illumination device according to First Embodiment of the present invention.

FIG. 7B is another crosssectional view illustrating another example of a manner of mounting a light-emitting diode in the illumination device according to First Embodiment of the present invention.

FIG. 7C is still another crosssectional view illustrating another example of a manner of mounting a light-emitting diode in the illumination device according to First Embodiment of the present invention.

FIG. 8 is yet another crosssectional view of an illumination device according to First Embodiment of the present invention.

FIG. 9A is a crosssectional view of an illumination device according to Second Embodiment of the present invention.

FIG. 9B is a crosssectional view of a modification of an illumination device according to Second Embodiment of the present invention.

FIG. 10 is a crosssectional view of an illumination device according to Third Embodiment of the present invention.

FIG. 11 is a plan view of an illumination device according to Fourth Embodiment of the present invention.

FIG. 12 is a plan view of an illumination device according to the related art.

FIG. 13 is a plan view of an illumination device according to Fifth Embodiment of the present invention.

FIG. 14A is a plan view of a modification of an illumination device according to Fifth Embodiment of the present invention.

FIG. 14B is a crosssectional view of the modification of an illumination device shown in FIG. 14A according to Fifth Embodiment of the present invention.

FIG. 15 is a plan view of an illumination device according to Sixth Embodiment of the present invention.

FIG. 16 is a perspective view of a display device according to Seventh Embodiment of the present invention.

FIG. 17 is a perspective view of a display device according to Eighth Embodiment of the present invention.

FIG. 18 is a perspective view of a display device according to Ninth Embodiment 9 of the present invention.

### DESCRIPTION OF THE EMBODIMENTS

Illumination devices and display devices using the illumination devices according to embodiments of the present invention will now be described.

### First Embodiment

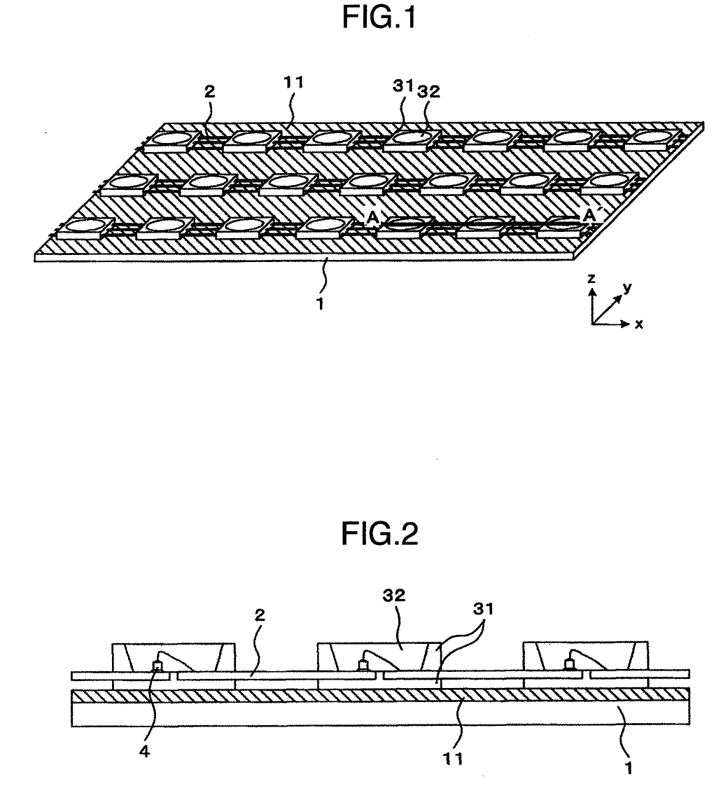

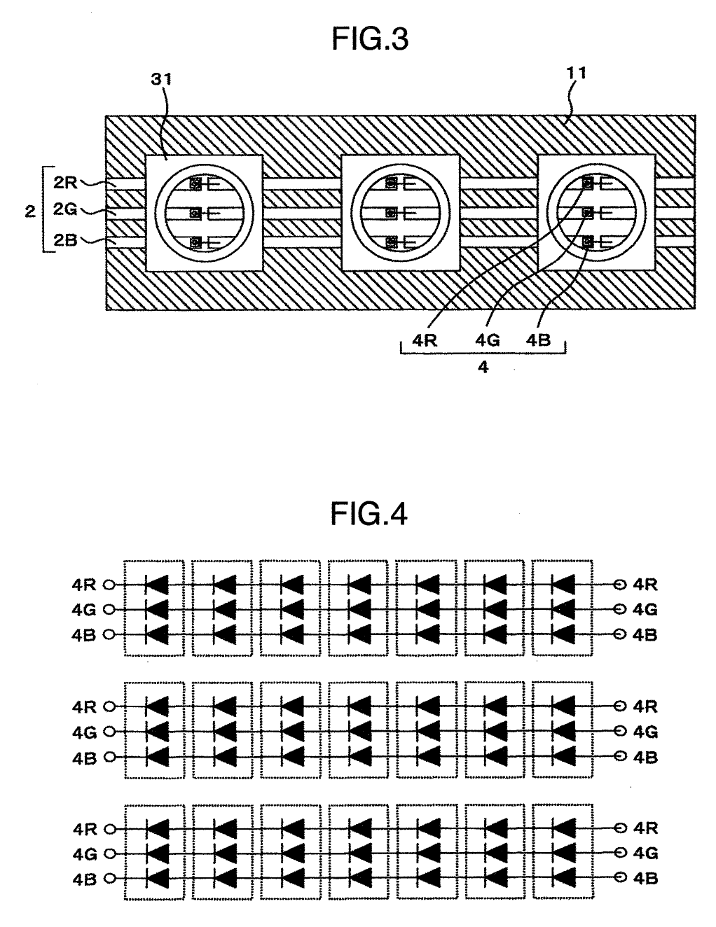

FIG. 1 is a perspective view illustrating an illumination device according to First Embodiment of the present invention. A crosssectional view taken along a line A-A′ on FIG. 1 is shown in FIG. 2, a plan view of the device is shown in FIG. 3, and an electric circuit of the device is shown in FIG. 4.

The illumination device according to this embodiment has a substrate 1, lead frames 2, reflecting resin blocks 31, transparent resin blocks 32, and plural light-emitting diodes 4. The substrate 1 has on one of its main surfaces an intermediate layer 11 on which the lead frames are placed. The intermediate layer may be an adhesive layer. The lead frames 2 include a train of lead frames 2R on which light-emitting diodes 4R are mounted for connection in series, a train of lead frames 2G on which light-emitting diodes 4G are mounted for connection in series and a train of lead frames 2B on which light-emitting diodes 4B are mounted for connection in series. The light-emitting diodes 4R, 4G and 4B emit light in red, green and blue wavelength regions, respectively. The transparent resin block 32 and a reflecting resin block 31 constitute one package. The lead frame trains 2R, 2G and 2B are arranged in such a manner that they are juxtaposed and a triad of light-emitting diodes 4R, 4G and 4B on the lead frames is included in each of the packages.

The illumination device according to this embodiment can be manufactured by a method as follows. First, lead frames are formed by means of the pressing or etching technique, and are plated as the case demands. Alternately, a plated lead frame material may be subjected to a pressing or etching operation. Next, the lead frames are pre-molded with a reflecting resin through the injection molding or transfer molding. Thereafter, a mounting process including coating of a silver paste, bonding of light-emitting diodes, hardening of the silver paste and wire-bonding follows. The mounting process may include formation of eutectic junction, bonding via bumps by thermocompression or ultrasonic, and so forth, depending on the type of the light-emitting diode chips. Thereafter, potting of the transparent resin and hardening of the resin are performed, and unnecessary parts of the lead frames are removed and bending operation is applied thereto, thereby to provide lead frames of a complete shape. Finally, the lead frames with the diode chips thereon are placed over a substrate with an adhesive layer interposed therebetween, and electrical connection is made to a power source and a control circuit to complete the illumination device. A protective circuit using zener diodes may be included in the illumination device or in the control circuit for protection of the light-emitting diodes.

In the illumination device according to this embodiment, a voltage is applied between opposite ends of a series of light-emitting diodes so that a forward current flows (from right-hand end to left-hand end in FIG. 4) to cause the light-emitting diodes 4 to emit light. The intensity of light emitted by the light-emitting diodes is readily variable by controlling the applied voltage, current or time duration of voltage application. In this embodiment, since light-emitting diodes 4R, 4G and 4B emitting light in wavelength regions for red, green and blue, respectively, which are the three primary colors for light, are arranged, mixture of the light beams with appropriate intensities from the diodes 4R, 4G and 4B can produce white light.

In the illumination device according to this embodiment, plural light-emitting diodes are arranged in series and driven. FIGS. 1 and 4 show an example of the arrangement in which, for each row, seven light-emitting diodes 4 are connected in series. The voltage to be applied to the opposite ends of the lead frame trains in the respective rows should be higher as the number of light-emitting diodes series-connected is larger.

When voltages are applied to the lead frame trains, since the applied voltages and the time duration of voltage application are different from one lead frame to another, a potential difference will appear between the lead frame trains 2R and 2G and between the lead frame trains 2G and 2B. In such a case, the related art structure in which the light-emitting diodes are mounted in the conventional manner subjected to migration through the surfaces of the substrate and of the adhesive layer, which will caused short-circuits.

In the illumination device according to this embodiment, in contrast, as shown in FIG. 2, the structure is such that the lead frame 2 is not in contact with the substrate 1 or the adhesive layer 11 and a gap is provided therebetween. Therefore, such voltage differences between juxtaposed lead frame trains do not cause migration through the surfaces of the substrate 1 and of the adhesive layer 11, with a result that the illumination device has a high reliability.

When the illumination device has triads of juxtaposed lead frame trains 2R, 2G and 2B as in this embodiment, for an increase of the reliability of the illumination device, a gap need not be always provided for all of the three lead frame trains in each triad of lead frame trains, but a gap may only be provided for an alternate one of the juxtaposed lead frame trains, i.e., for the intermediary lead frame train 2G only, or for the outer two lead frame trains 2R and 2B on both sides of the lead frame train 2G in each triad of lead frame trains, though the degree of increase of the reliability may be somewhat smaller as compared to the case in which gaps are provided for all of the three lead frame trains in each triad of lead frame trains.

Further, in this embodiment, it is possible to make use of the gaps provided between the substrate 1 and the lead frames 2 in such a manner that additional wirings, optical sensors and/or thermal sensors may be arranged in the gaps under the lead frames. In addition, such gaps may be used to accommodate fitting pieces such as screws used for fastening the substrate 1 to an outer frame or case, so that the lead frames need not bypass the fitting pieces, thereby achieving an additional advantage of an increase in the degree of freedom of design.

Description will now be made of indispensable ones of the members which constitute the illumination device and their associated arrangement according to this embodiment.

The substrate 1 is made of copper, aluminum, a surface-treated metal such as alumite, ceramics such as aluminum nitride, silicon nitride or alumina, or a resin such as a glass epoxy resin. The substrate 1 may be a so-called printed wiring board having one surface provided with a wiring pattern for an electric circuit. Also, the substrate 1 may be provided with screws or the like for fastening the lead frames 2, the reflecting resin blocks 31, the transparent resin blocks 32 and/or a control circuit.

As shown in FIGS. 1 and 2, it is preferable to provide on the substrate an adhesive layer 11 for fixing the lead frames 2, the reflecting resin blocks 31 and the transparent resin blocks 32. The adhesive layer 11 may be little adhesive so that it serves to effectively conduct heat generated by the light-emitting diodes to the substrate 11 thereby ensuring heat dissipation and serves to assure, when the substrate 11 is an electrically conductive substrate made of aluminum or the like, insulation between the lead frames 2 and the substrate 1.

The adhesive layer 11 may take various forms such as; a film coated on the substrate 1, a sheet attached to the substrate 1, a layer of grease-like material coated on the substrate 1, and so forth. The layer 11 may contain a filler.

The substrate 1 may be one substrate for one illumination device, or plural substrates 1 may constitute a wiring circuit board, being arrayed in matrix or in a strip arrangement on a base member such as of a casing.

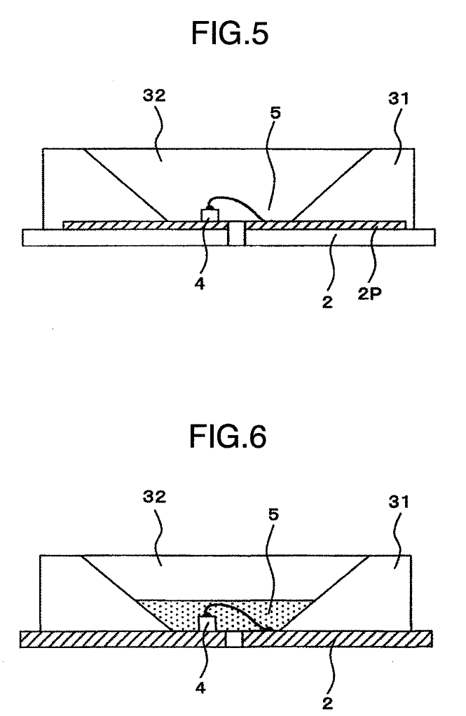

The lead frames 2 are made of copper, a copper alloy or a 4-2 alloy. The lead frames are plated with gold, silver or nickel to enhance the mounting reliability and the efficiency of reflection of light from the light-emitting diodes. Particularly, silver having a high reflectance for visible light radiation, is indispensable for an increase of the light utility efficiency, but it is disadvantageouly subject to migration. Therefore, as shown in FIG. 5, in order to suppress generation of migration, application of the silver plate 2P should be limited to an area on the surface of the read frame which is inside the periphery of the seal by the reflecting resin block 31 and the transparent resin block 32, and limited only to the surface side of the lead frame 2 on which the light-emitting diode 4 is mounted, thereby ensuring an enhanced reliability. Further, the heat dissipation efficiency and the light utility efficiency may be enhanced by use of lead frames having a thickness which is partially changed, such lead frames being called special form lead frames in the field of lead frames.

In the above description, although lead frames have been of flat rectangular for simplicity sake of explanation, they should not be limited thereto, and may be of any other forms having larger areas or of more complex forms in the light of the heat dissipation efficiency.

The light-emitting diodes 4 may include semiconductor layers which have various compositions, have various structures, and are formed in various manufacturing processes, depending on an optional selection of the color of light emission from the whole visible light wavelength region. Further, a combination of light-emitting diodes capable of emitting light of different colors makes it possible to mix the colors to attain a light emission of any color. For example, a mixture of light emissions of red, green and blue makes white light.

Further, as shown in FIG. 6, a fluorescent material 5 may be placed around the light-emitting diode 4 so that light emissions from the light-emitting diode 4 and from the fluorescent material are mixed; for example, a blue light emission from the light-emitting diode 4 and a yellow light emission from the fluorescent material 5 are mixed to obtain a white light emission, or an ultraviolet light emission from the light-emitting diode 4 and red, green and blue light emissions from the fluorescent materials 5 are mixed to obtain a white light emission. The light emissions to be mixed should be appropriately selected for mixture depending on the use of the illumination device. In FIG. 6, although the transparent resin block 32 is provided on the fluorescent material 5, it will be needless to say that the reflecting resin block 32 may be dispensed with, or the fluorescent material 5 may be dispersed in the reflecting resin block 31.

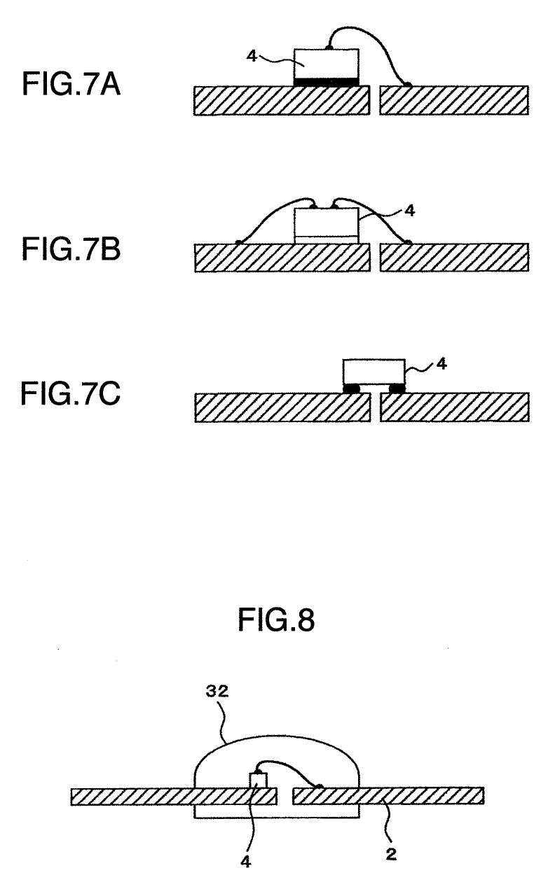

The light-emitting diodes 4 are mounted in different manners depending on the disposition of two electrodes, i.e., anode and cathode. Specifically, the light-emitting diode 4 may have the two electrodes (anode and cathode) on its upper and lower surfaces, respectively, which are bonded as shown in FIG. 7A, or may have the two electrodes on its upper surface which are bonded as shown in FIG. 7B, or may have the two electrodes on its lower surface which are bonded as shown in FIG. 7C. Further, the light-emitting diode may have more than two electrodes, depending on its size and/or kind.

In the following description of the present invention and its embodiments, it is assumed for convenience sake that the light-emitting diodes are mounted in the manner as shown in FIG. 7A, but they may be mounted in the manner shown in FIG. 7B or 7C or in any other similar manner. It is also assumed that they emit red, green and blue light radiation, but they may emit radiation of other set of colors, which attains, needles to say, the same effect.

It is preferable that the reflecting resin blocks 31 have a high reflectance, are heat-resistant, are light-resistant (UV-resistant), are low in moisture permeability, have a high adhesion, and/or are less subject to cracks. The resin blocks 31 may be produced by molding such as transfer molding or injection molding. Preferably, the reflecting resin blocks 31 are integrally molded along with the read frames 2, but they may be prepared separately so that the resin blocks 31 are bonded to the lead frames 2. Preferably, the resin blocks 31 have a tapered shape from the viewpoint of the light utility efficiency. For the purpose of a high reflectance, the material for the resin blocks 31 is not limited only to a white resin, but also may be a white pigment, a resin with an additive of particles or a resin having many pores therein to utilize multiple reflection at interfaces, or a resin coated with metal films of a high reflectance by deposition, sputtering or printing, or coated with dielectric multi-layers thereby to enhance the reflectivity of the metal films. It is noted that when the reflecting resin blocks 31 have a surface free from unevenness, a so-called mirror surface will be obtained.

It is preferable that the transparent resin blocks 32 have a high transmissivity, are heat-resistant, are light-resistant (UV-resistant), are low in moisture permeability, have a high adhesion, and/or are less subject to cracks. Preferably, the transparent resin blocks 32 have a high refractive index which is as close as possible to that of the light-emitting diodes 4 from the viewpoint of extracting light from the diodes 4. The transparent resin for forming the transparent resin blocks 32 is placed within the reflecting resin blocks 31 by dispensing or potting and is hardened by thermal curing or UV-hardening or any other hardening steps. The size and shape of the transparent resin blocks 32 can be optionally determined in accordance with the design policy for the illumination device and various properties of the resin such as the viscosity and thixotropy. Further, it is also possible to improve the efficiency of extracting light from the light-emitting diodes by adding particles having a high refraction index to the resin to increase its refraction index, and it is also possible to improve the uniformity by giving diffusibility to the transparent resin.

Aside from a combination of the reflecting resin blocks 31 and the transparent resin blocks 32 heretofore described, the transparent resin blocks 32 free from the reflecting resin blocks 31 may be molded integrally with the lead frames 2 by transfer molding or injection molding. In this connection, the transparent resin blocks 32 are formed into a lens-like shape so that they are capable of refraction and total reflection of light. Utilization of the refraction and reflection of the transparent resin blocks 32 makes it possible to optionally control the directivity of the light emissions from the light-emitting diodes 4.

In the following description of the present invention and its embodiments, it is assumed for convenience sake that both the reflecting resin blocks 31 and the transparent resin blocks 32 are employed, the description is equally applicable to a structure such as shown in FIG. 8 in which the transparent resin blocks 32 are employed for sealing the light-emitting diodes 4, without the reflecting resin blocks 31, unless otherwise stated.

### Second Embodiment

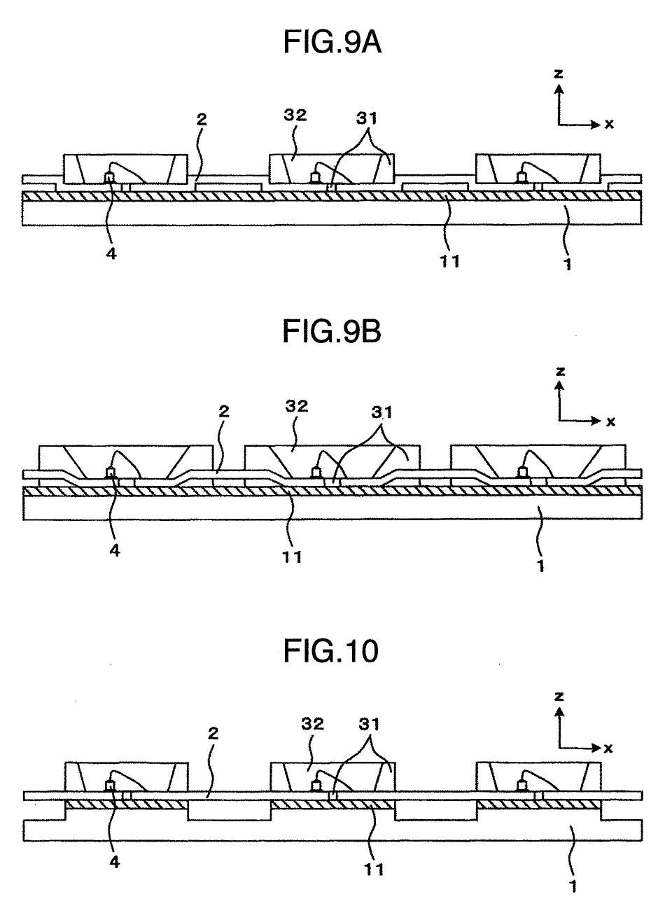

FIGS. 9A and 9B are crosssectional views illustrating an illumination device according to Second Embodiment of the present invention. In this embodiment, each lead frame has clinched portions. The clinched portion has rising parts standing off from the substrate. The rising parts may be achieved by bending a lead frame member. The bending may be carried out after the lead frame members have been molded integrally along with the resin for the reflecting resin blocks 31. Alternately, as shown in FIG. 9B, lead frame members may be first subjected to a bending process and then to a process of integral molding along with the resin for the reflecting resin blocks 31. In this embodiment, the provision of the clinched portions to the lead frames 2 makes gaps between the substrate 1 (adhesive layer 11) and the lead frames 2, whereby the illumination device enjoys the same effect as that in the above-described embodiment.

Further, as can be seen from FIGS. 9A and 9B, those portions of the lead frames 2 on which the light-emitting diodes 4 are mounted are contacted to the substrate 1 via the adhesive layer 11, in other words, the lead frames 2 are contacted to the substrate 1 without the reflecting resin blocks 31 and the transparent rein blocks 32 intervening therebetween. Therefore, heat generated by the light-emitting diodes 4 can be efficiently dissipated to the substrate 1, which makes it possible to provide an illumination device having a high reliability, suppressing deterioration of the efficiency.

### Third Embodiment

FIG. 10 is a crosssectional view illustrating an illumination device according to Third Embodiment of the present invention. In this embodiment, the substrate 1 has recesses on its one surface so that the recesses provide gaps between the substrate 1 and the lead frames 2. Thus, the illumination device according to this embodiment enjoys the same effect as in the above-described embodiment. Further, as can be seen from FIG. 10, those portions of the lead frames 2 on which the light-emitting diodes 4 are mounted are contacted to the substrate 1 via the adhesive layer 11, in other words, the lead frames 2 are contacted to the substrate 1 without the reflecting resin blocks 31 and the transparent rein blocks 32 intervening therebetween. Therefore, heat generated by the light-emitting diodes 4 can be efficiently dissipated to the substrate 1, which makes it possible to provide an illumination device having a high reliability, suppressing deterioration of the efficiency.

### Fourth Embodiment

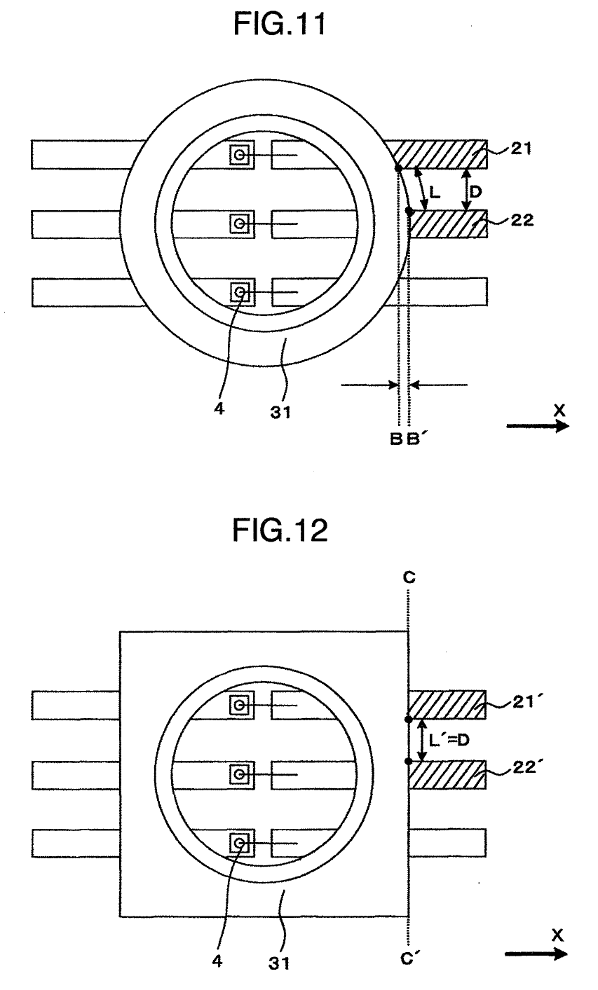

FIG. 11 is a plan view illustrating Fourth Embodiment of the present invention in which one reflecting resin block 31 along with a sealed portion and its associated structure is shown for convenience sake of explanation, while FIG. 12 is a plan view of the related art structure shown for comparison. The structure shown in FIG. 11 according to this embodiment is distinct from that shown in FIG. 12 according to the related art in the shape of the reflecting resin block 31.

In this embodiment, adjacent lead frames 21 and 22, for example, are exposed from the reflecting resin block 31 (exposed portions being indicated by hatched areas) in such a manner that the exposure starting points B and B′ on the lead frames 21 and 22 are at different positions as viewed in the direction perpendicular to the lead frames i.e., at different positions on the horizontal axis or x-direction axis as indicated in FIG. 11. In the related art shown in FIG. 12, adjacent lead frames 21′ and 22′ are exposed from the reflecting resin block 31 (exposed portions being indicated by hatched areas) with their exposure starting points C and C′ coincident with each other. Assuming that the distance between adjacent lead frames 21 and 22 and the distance between lead frames 21′ and 22′ are both represented by D, a distance between the exposure starting points B and B′ on the lead frames 21 and 22 measured along the side wall of the reflecting resin block 31 is represented by L (FIG. 11), and a distance between the exposure starting points C and C′ on the lead frames 21′ and 22′ is represented by L′ (FIG. 12), the following relations stand: L>L′=D.

When a potential difference appears between the lead frames 21 and 22 and between lead frames 21′ and 22′, and if moisture or contaminants such as foreign particles are attached to the side wall of the package, electric current may flow along the side wall surface via migration to cause a undesirable short-circuit in the conventional structure. However, in the structure according to this embodiment, since the distance between the exposure starting points on adjacent lead frames measured along the side wall is longer than that in the conventional structure. Thus, the illumination device according to this embodiment enjoys, as in the above-described embodiments, a higher reliability with the probability of occurrence of the above-mentioned problems being decreased.

It is apparent that these effects are equally attainable with the structures according to the described embodiments in which gaps are not provided between the lead frames 2 and the substrate 1.

### Fifth Embodiment

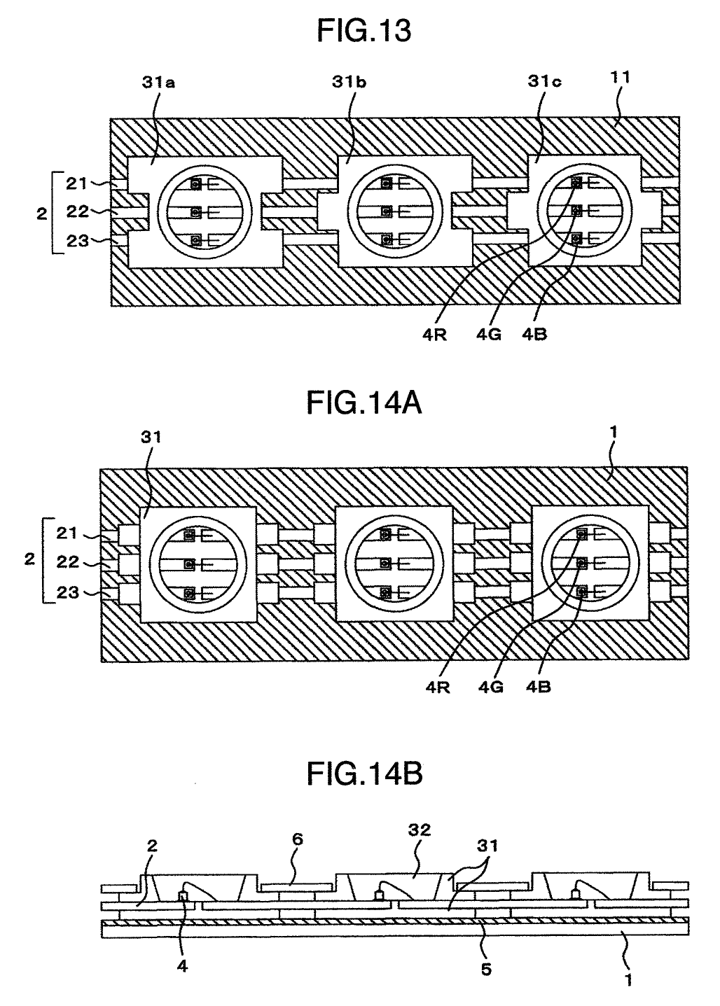

FIG. 13 is a plan view illustrating Fifth Embodiment of the present invention in which the reflecting resin blocks employed in this embodiment have depressed portions or protruding portions in a plane parallel with the substrate, the protrusion and depression being in a direction substantially parallel with the series-connected lead frames. The manner of providing the depressed portions and/or protruding portions to the resin blocks are such that one block may have two depressed portions or two protruding portions, one located at each of the opposite ends of the block in a horizontally symmetrical arrangement, as indicated at 31a or at 31c in FIG. 13, or one block may have one protruding portion located at one end and one depressing portion at the other, opposite end, as indicated at 31b in FIG. 13.

In the conventional structure as shown in FIG. 12 in which the reflecting resin blocks 31 have no depressed portions and/or protruding portions, when a potential difference appears between the lead frames 21′ and 22′ and if moisture or contaminants such as foreign particles are attached to the side wall of the package, electric current may flow along the side wall surface via migration to cause a undesirable short-circuit. However, in the structure according to this embodiment, since the distance between the lead frames 21 and 22 measured along the side wall of the reflective resin blocks 31b or 31c is made long, the probability of occurrence of the above-mentioned problems can be decreased.

In this embodiment, as shown in plan view in FIG. 14A and in crosssectional view in FIG. 14B, the depressed portions and protruding portions of the reflecting resin blocks 31 may be formed at a level lower than that of the uppermost surface of the resin blocks 31. This structure, in addition to the above-mentioned advantages, enjoys a further advantage such that reflecting sheets 6 can be easily provided on the depressed portions and protruding portions of the reflecting resin blocks 31 at a low level in an aligned arrangement.

It is apparent that these effects are equally attainable with the structures according to the described embodiments in which gaps are not provided between the lead frames 2 and the substrate 1.

### Sixth Embodiment

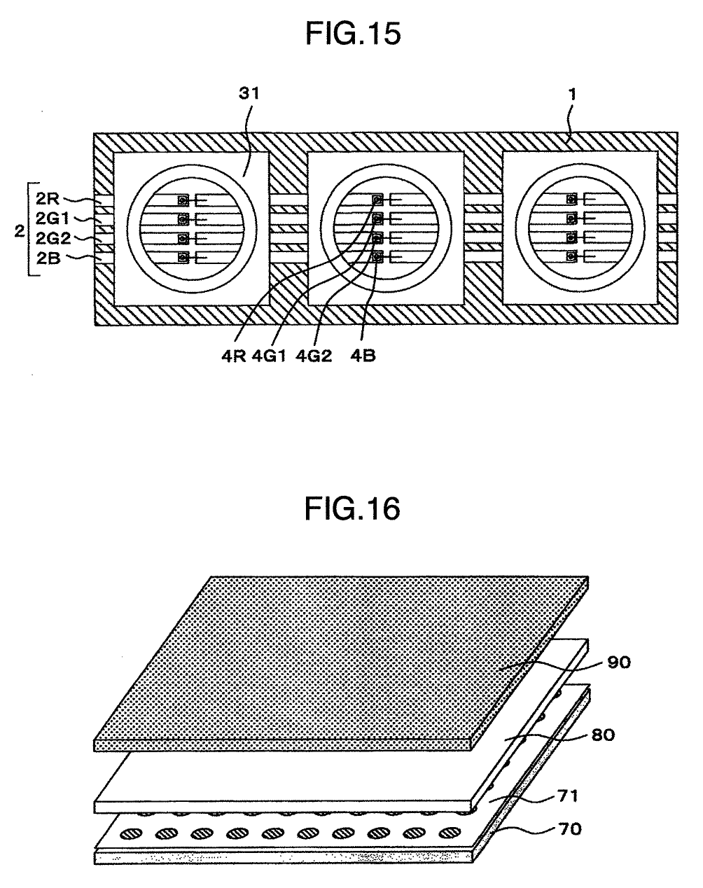

FIG. 15 is a plan view illustrating Sixth Embodiment of the present invention in which four trains of lead frames 2R, 2G1, 2G2 and 2B are juxtaposed, light-emitting diodes 4R capable of emitting light in the red wavelength region being mounted on the lead frame train 2R, light-emitting diodes 4G1 capable of emitting light in the green wavelength region being mounted on the lead frame train 2G1, light-emitting diodes 4G2 capable of emitting light in the green wavelength region being mounted on the lead frame train 2G2, and light-emitting diodes 4B capable of emitting light in the blue wavelength region being mounted on the lead frame train 2B. In the illumination device according to this embodiment, a mixture of red, green and blue light emissions from the light-emitting diodes 4R, 4G1, 4G2 and 4B reproduces white light. Generally, the emission efficiency of green light-emitting diodes is lower than those of red and blue light-emitting diodes, and therefore, use of sets of light-emitting diodes, each set consisting of one red light-emitting diode, two green light-emitting diodes and one blue light-emitting diode, leads to an illumination device which is capable of reproducing white light by an effective mixture of light emissions from the sets of light-emitting diodes as described above.

In the structure according to this embodiment, the lead frame trains 2G1 and 2G2 on which light-emitting diodes capable of emitting light of the same color are arranged so as to be adjacent to each other. Since almost the same driving voltage is applied to the lead frame trains 2G1 and 2G2, there is little potential difference between them, so that a short-circuit due to migration is effectively suppressed to enhance the reliability of the structure. Although this embodiment makes use of four lead frame trains as an example, when more lead frame trains are used to constitute an illumination device, similar effects can be expected by arranging lead frame trains on which light-emitting diodes capable of emitting light of the same color so as to be adjacent to each other so that the potential difference between those lead frame trains is made small.

### Seventh Embodiment

FIG. 16 is a perspective view illustrating a display device according to an embodiment of the present invention. The display device includes an illumination device 70 having the illumination device according to any one of the above-described embodiments or an array of such illumination devices, an optical element assembly 80 for making more uniform light emitted by the illumination device 70 and for controlling directivity of the light, a reflector sheet 71 and a nonluminous type panel 90. The reflector sheet 71 has holes opened at portions in alignment with the sealing resin blocks in the illumination device(s) or in the illumination device 70. The reflector sheet 71 functions to reflect light, which is reflected by the optical element assembly 80 to the illumination device 70 side, back toward the nonluminous type panel 90. By on-off controlling, on pixel-by-pixel base, light from the illumination device 70 on the back side of the nonluminous type panel 90, any picture or character can be displayed on the panel 90. The nonluminous type panel 90 in this embodiment may be operative in any mode such as a liquid crystal display mode, an electrophoresis display mode, an electrochromic display mode, a charged particle flow display mode, and all other transmission type display modes in which the panel itself does not emit light. The optical element assembly 80 may be constituted by one of or a combination of two or more of a diffusion plate, a light guiding plate 81, a prism sheet and a polarized reflection diffusion sheet thereby to provide an optional directivity and uniformity of light.

The display apparatus according to this embodiment utilizes, as a backlight source, one or more illumination device 70 according to any one of the above-described embodiments. The backlight source, having a high reliability, contributes to an increase of the reliability of the overall display device. The gaps provided in the illumination device can be used as spaces for screw-fastening the illumination device to another circuit board or a case, thereby effectively facilitating design of the overall device.

Since the light-emitting diodes have a high on-off switching and response speed as compared with the conventional backlight source including a fluorescent lamps, they contribute to an improvement of the picture quality in the display device such as moving picture reproducing properties and contrast. In this case, the light-emitting diodes in the illumination device 70 may be driven in such a manner that the juxtaposed plural series of horizontally arranged light-emitting diodes are sequentially lighted in synchronism with the picture signal of the nonluminous type display panel 90.

Specifically, when the illumination device in the display device has a backlight source constituted by red, green and blue light-emitting diodes, the display device is capable of a broad range of color reproduction to provide very fresh pictures as compared to those having the conventional backlight source which makes use of fluorescent lamps. Further, the light-emitting diodes, being free from mercury, are advantageously friendly to the environment.

### Eighth Embodiment

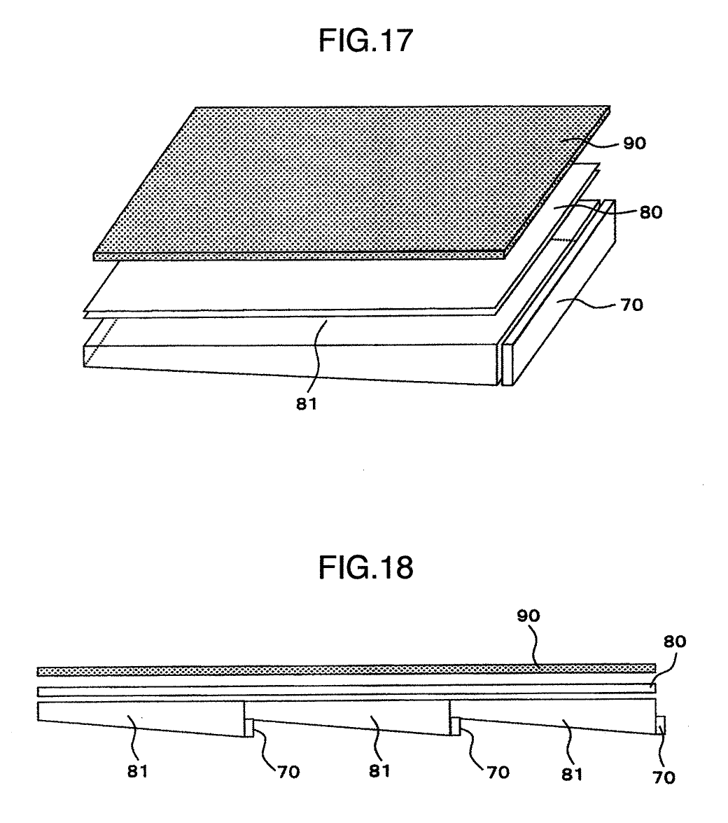

FIG. 17 is a perspective view illustrating a display device according to another embodiment of the present invention. The display device includes an illumination device 70 similar to that in the above-described embodiment and a light guiding plate 81 aside of which the illumination device 70 is arranged so that light is incident on the light guiding plate 81. The light guiding plate 81 has on its back surface a high reflectance sheet and light incident on the light guiding plate 81, after having been subjected to plural times of reflection, emanates from its front surface. Over the light guiding plate 81, there is provided an optical element assembly 80, which may include one of or a combination of two or more of a prism sheet, a polarized reflection diffusion sheet, and any other kind of optical element. A nonluminous type display panel 90 is placed on the assembly 80.

This embodiment also enjoys effects similar to those described with respect to the above embodiment, and is particularly useful, when display devices having a small display screen size are to be manufactured, owing to use of the illumination device 70 arranged aside of the guiding plate 81, with the thickness of the overall display device being advantageously very small.

### Ninth Embodiment

FIG. 18 is a crosssectional view illustrating a display device according to another embodiment of the present invention. The display device includes wedge-shaped light guiding plates 81 arranged in matrix or in rows and columns, and illumination device 70 similar to those described in connection with the above embodiments which are provided on one side surface of each wedge-shaped light guiding plate 81. The manner of travel of light from the illumination devices to the nonluminous type panel 90 is similar to that in the above embodiment.

This embodiment also enjoys effects similar to those described with respect to the above embodiment, and is particularly useful when display devices having a large display screen size are to be manufactured. When it is required that the display screen size be changed, any change of the display screen size can be effectively attained by changing the numbers of the light guiding plates 81 and of the associated illumination devices.

It should be further understood by those skilled in the art that although the foregoing description has been made on embodiments of the invention, the invention is not limited thereto and various changes and modifications may be made without departing from the spirit of the invention and the scope of the appended claims.

1. An illumination device including:
a substrate;
a plurality of lead frames provided on said substrate;
a plurality of light-emitting diodes connected in series by said plurality of lead frames; and
transparent resin blocks placed on said lead frames and sealing said light-emitting diodes,
in which gaps are provided between said lead frames and said substrate.

2. An illumination device according to claim 1, wherein a reflecting resin block is provided to surround each of said light-emitting diodes on said lead frames so that the transparent resin blocks are placed on each reflecting resin block thereby to seal said light-emitting diodes.

3. An illumination device according to claim 2, wherein each of said lead frames has clinched portions so that said each lead frame is partly not in contact with said substrate.

4. An illumination device according to claim 3, wherein said clinched portion of each lead frame has a rising part standing off from said substrate.

5. An illumination device according to claim 3, wherein said clinched portion is provided at a region where said lead frame is in contact with said reflecting resin block or with said transparent resin block.

6. An illumination device according to claim 2, wherein said substrate has recesses on one surface on which said lead frames are provided so that said gaps are formed between said substrate and said lead frames at said recesses.

7. An illumination device according to claim 2, wherein a silver layer is provided between each of said light-emitting diodes and its associated lead frame.

8. An illumination device according to claim 2, wherein an adhesive layer is provided on one surface of said substrate on which said lead frames are placed.

9. An illumination device according to claim 2, wherein at least those of said lead frames which are adjacent to each other have areas contacted to their associated reflecting resin blocks or to their associated transparent resin blocks at different positions from each other.

10. An illumination device according to claim 2, wherein at least those of said lead frames which are adjacent to each other are exposed from their associated reflecting resin blocks or from their associated transparent resin blocks at positions different from each other as viewed in a direction transverse to the series-connected light emitting diodes.

11. An illumination device according to claim 10, wherein said reflecting resin blocks or said transparent resin blocks have depressed portions or protruding portions in a plane parallel with said substrate, said lead frames being exposed from said depressed or protruding portions of said reflecting resin blocks or of said transparent resin blocks.

12. An illumination device according to claim 2, wherein said light-emitting diodes include those capable of emitting light in a red wavelength region, those capable of emitting light in a green wavelength region and those capable of emitting light in a blue wavelength region, and those emitting light of the same colors are connected in series through said respective lead frames.

13. An illumination device according to claim 11, wherein the number of the lead frames series-connecting light-emitting diodes capable of emitting light in a red wavelength region, that of the lead frames series-connecting light-emitting diodes capable of emitting light in a green wavelength region and that of the lead frames series-connecting light-emitting diodes capable of emitting light in a blue wavelength region are in a ratio of 1:2:1.

14. An illumination device according to claim 12, wherein two trains of lead frames series-connecting light-emitting diodes which emit light in a green wavelength retion are arranged to be adjacent to each other.

15. An illumination device according to claim 2, wherein said light-emitting diodes include those capable of emitting light in a blue wavelength region or in a purple wavelength region, and a fluorescent material is provided on said reflecting resin blocks, the fluorescent material being excitable with light in the blue wavelength region or in the purple wavelength region for emission of light.

16. A liquid crystal display device comprising:
a backlight source including at least one illumination device each having a substrate, a plurality of lead frames provided on said substrate, a plurality of light-emitting diodes connected in series by said plurality of lead frames, and transparent resin blocks placed on said lead frames and sealing said light-emitting diodes;
a liquid crystal display panel to be supplied with light from said backlight source; and
an assembly of optical elements arranged between said backlight source and said liquid crystal display panel for controlling uniformity and directivity of light from said backlight source, in which gaps are provided between said lead frames and said substrate.

17. A liquid crystal display device according to claim 16, wherein a reflecting resin block is provided to surround each of said light-emitting diodes on said lead frames so that said transparent resin blocks are placed one on each reflecting resin block thereby to seal said light-emitting diodes.

18. A liquid crystal display device according to claim 17, said backlight source includes said illumination device arranged on the side surface of said liquid crystal display panel and includes a light guiding plate for letting in light from said illumination device to said liquid crystal display panel.

19. A liquid crystal display device according to claim 16, wherein said backlight source has plural sets of an illumination device and a light guiding plate, said light guiding plate in each set letting in light from its associated illumination device to said liquid crystal display panel, said plural sets being arranged in rows and columns.
